(19) United States
(12) Patent Application Publication
(10) Pub. No.: US 2008/0135469 A1
(43) Pub. Date: Jun. 12, 2008

(54) Two-level fuel filter device

(75) Inventors: Laurent Fremont, Douains (FR); Mathieu Petiteaux, Melle (FR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: FILTRAUTO, Guyancourt (FR)

(21) Appl. No.: 11/610,247

(22) Filed: Dec. 13, 2006

(30) Foreign Application Priority Data
Dec. 12, 2006 (FR) 06 10841

(51) Int. Cl. B01D 36/04; B01D 36/02

(52) U.S. Cl. 210/234; 210/235; 210/314; 210/307

(57) ABSTRACT

A device for filtering fuel, in particular diesel, the device comprising a housing containing a flow circuit, a first particle filter element, a second particle filter element, and a water separation fabric. The fuel flow circuit extends between an inlet and an outlet. The first particle filter element is adapted to cause the water contained in the fuel to coalesce in the form of droplets. The second particle filter element is disposed downstream from the first filter element in the fuel flow circuit. The water separation fabric is interposed between the first filter element and the second filter element in the fuel flow circuit and is adapted to form a barrier against droplets of water.

### FIELD OF THE INVENTION

The invention relates to a device for filtering fuel, in particular diesel, for removing the particles and the water contained in the fuel.

### CONTEXT OF THE INVENTION

Various devices of this type are known. US-2006/0006109 discloses a device comprising a housing containing:
a fuel flow circuit extending between an inlet and an outlet;
a non-filter element adapted to cause the water contained in the fuel to coalesce in the form of droplets; and
a particle filter element disposed downstream from the non-filter element in the fuel flow circuit.

### SUMMARY OF THE PRESENT INVENTION

The invention seeks to provide a device that is simple and robust, presenting improved quality when filtering particles and separating water, and without increasing price.

To do this, in accordance with the invention, the housing contains:
a fuel flow circuit extending between an inlet and an outlet;
a first particle filter element adapted to cause the water contained in the fuel to coalesce in the form of droplets;
a second particle filter element disposed downstream from the first filter element in the fuel flow circuit; and
a water separation fabric interposed between the first filter element and the second filter element in the fuel flow circuit and adapted to form a barrier against droplets of water.

Thus, the first filter element performs coarse filtering, thereby defining a capacity filter element, while increasing the size of fine drops of water, while the second filter element performs fine filtering that is more effective against particles that have passed through the first filter element. The first filter element and the fabric have a combined effect of effectively separating the water from the fuel. The fuel passing through the second filter element contains very little water, so the particle filtering performed by the second element is improved. Furthermore, it enables filter materials to be used that are less good at withstanding water, but that are more effective in filtering particles.

In order to optimize the combined effects of the first filter element and the hydrophobic fabric, in accordance with the invention the first filter preferably presents surface energy lying in the range 40 millinewtons per meter (mN/m) to 60 mN/m, and the hydrophobic fabric presents surface energy lying in the range 20 mN/m to 30 mN/m.

Thus, the first filter avoids excessive accumulation of water droplets that would run the risk of closing certain pores of the filter, leading to head losses and flow disparities through the filter, thus generating a loss of efficiency. Furthermore, the first filter causes droplets of water group together in a manner that is adapted to the water barrier formed by the hydrophobic fabric.

According to another characteristic in accordance with the invention, the first filter element and the second filter element are preferably tubular, share a common axis, and are disposed one extending the other.

The ratio between the efficiency and the size of the filter is thus improved.

According to an additional characteristic in accordance with the invention, and preferably, the first filter element and the second filter element define internally an inside space in which a pump is disposed.

Thus, the pump can be integrated in the device without significantly increasing its size.

According to another additional characteristic in accordance with the invention, the pump is disposed downstream from the separation fabric in the fuel flow circuit.

Thus, the pump is less likely to reduce the efficiency with which water contained in the fuel is separated out.

According to another characteristic in accordance with the invention, and advantageously, the pump is disposed in a fuel-tight tubular sheath presenting a bottom, said sheath defining a container fed upstream from the pump in the fuel flow circuit by at least one feed orifice remote from the bottom, and the pump presenting an inlet and an outlet, said inlet being disposed between the feed orifice and the bottom of the sheath.

Thus, when the housing is open, in particular for the purpose of replacing the filters, there is a reduction in the risk of the pump no longer being lubricated or of the pump racing because it is sucking in air.

In accordance with the invention, the device also preferably presents the following characteristics:
the sheath is tubular and extends in the inside space; and
the housing comprises a body in which the sheath is integrated, and said feed orifice is pierced radially through the sheath.

The device is thus simpler to manufacture.

According to an additional characteristic in accordance with the invention, a secondary water separation fabric is disposed in said at least one feed orifice, and a bottom end plate secured to the bottom end of the first filter element includes a settling zone for collecting the water separated by the second fabric, and which is disposed between the first element and the secondary fabric in the fuel flow circuit.

This improves separation of water from the fuel.

According to another additional characteristic in accordance with the invention, the sheath is overmolded on the secondary water separation fabric.

According to another characteristic in accordance with the invention, the first filter element, the second filter element, and the separation fabric preferably define a removable one-piece filter unit.

This makes it easier to install and replace the first filter element, the second filter element, and the separation fabric.

According to an additional characteristic in accordance with the invention, and preferably, the filter unit having a plate separating the first filter element and the second filter element, said plate being provided with at least one lip facing towards the first filter element, and the pump is disposed between the first filter element and the second filter element in the fuel flow circuit.

Thus, when the plate and the sealing lip do not enable complete sealing to be achieved, leakage takes place from downstream to upstream in the fuel flow circuit. The quality of the filtering performed by the device is then not degraded.

According to another characteristic in accordance with the invention, the device further includes a valve having a closed position in which it prevents fuel from flowing through the outlet of the device, and an open position in which it allows fuel to flow through the outlet of the device, said valve being urged towards its closed position by pressure means and presenting a rod coming to bear against the filter assembly comprising the first filter element, the second filter element, and the separation fabric and serving to push the valve towards its open position.

Thus, in the absence of the filter, fuel cannot leave the device. Consequently, the risk of unfiltered fuel leaving the device is reduced.

According to an additional characteristic in accordance with the invention, and preferably, the filter assembly includes means for isolating the downstream end of the pump from the upstream end of the pump, such that in the absence of the filter assembly, the downstream end of the pump and the upstream end of the pump communicate with each other than through the pump.

This reduces the risk of excess pressure inside the device or of the pump becoming heated.

According to another characteristic in accordance with the invention, and preferably, the device further comprises a settling zone upstream from the first filter element in the fuel flow circuit for collecting the water separated from the fuel by the first filter element.

Larger droplets of water are thus separated from the fuel on entering the device.

### BRIEF DESCRIPTION OF THE FIGURES

Other characteristics and advantages of the present invention appear from the following detailed description given with reference to the accompanying drawings, in which:

FIG. 1 shows a first embodiment of a filter device in accordance with the invention;

FIG. 2 is on a larger scale and shows a detail identified as II in FIG. 1;

FIG. 3 shows the filter unit of the FIG. 1 filter device;

FIG. 4 shows the FIG. 1 filter device open, after removing the filtering unit;

FIG. 5 shows the FIG. 1 filter device, without the filter unit;

FIG. 6 shows a second embodiment of a filter device in accordance with the invention;

FIG. 7 is on a larger scale and shows a detail identified at VII in FIG. 6;

FIG. 8 shows a third embodiment of a filter device in accordance with the invention; and

FIG. 9 shows a fourth embodiment of a filter device in accordance with the invention.

### DETAILED DESCRIPTION OF PREFERRED EMBODIMENTS

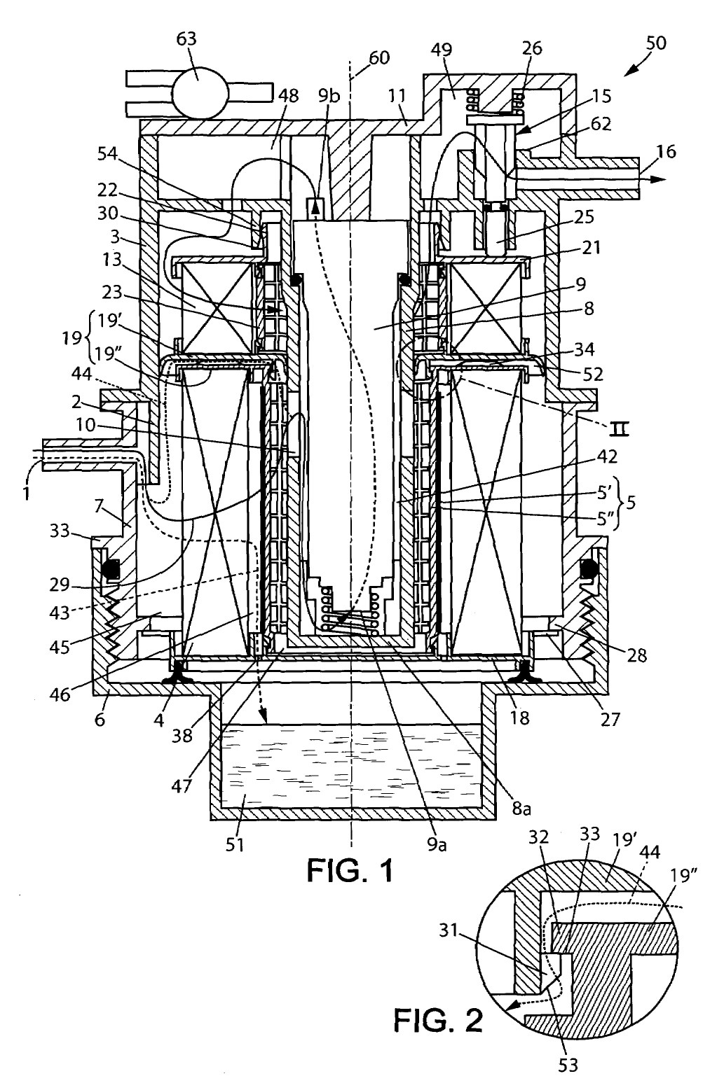

FIG. 1 shows a diesel filter device 50 comprising a housing and a filter unit 24 disposed inside the housing. The housing has a cannula 1 forming an inlet and a cannula 16 forming an outlet. The diesel flows through the device 50 along a circuit 29 between the inlet 1 and the outlet 16.

The housing essentially comprises a cover 11, an upper body 3, a lower body 7, and a bottom 6 screwed onto the lower body 7. These four main elements of the housing are advantageously made of plastics material. The cover 11, the upper body 3, and the lower body 7 are preferably secured to one another by welding. This welding may be of the ultrasound, laser, hot-blade, or analogous type. Such methods serve to heat the plastics material so as to melt it locally at contacting surfaces between the pairs of parts to be assembled together. The parts to be assembled together are then pressed against one another so that the partially-molten plastics material of each part mixes with that of another part. When the plastics materials cool down, they bond together in definitive manner. The cover 11, the upper body 3, and the lower body 7 are thus bonded together in leaktight manner. In a variant, other means enabling these elements to be secured to one another in leaktight manner could alternatively be provided.

The bottom 6 is secured releasably on the body 7 by a screw thread, so as to come into abutment against an annular collar 33 projecting radially outwards from the lower body 7 to form an abutment for the bottom 6. An O-ring is provided to provide sealing between the bottom 6 and the lower body 7.

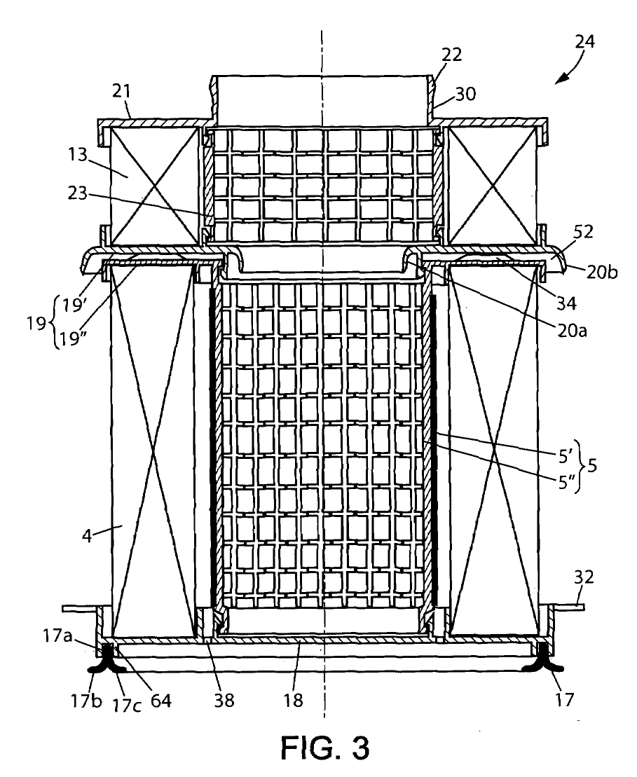

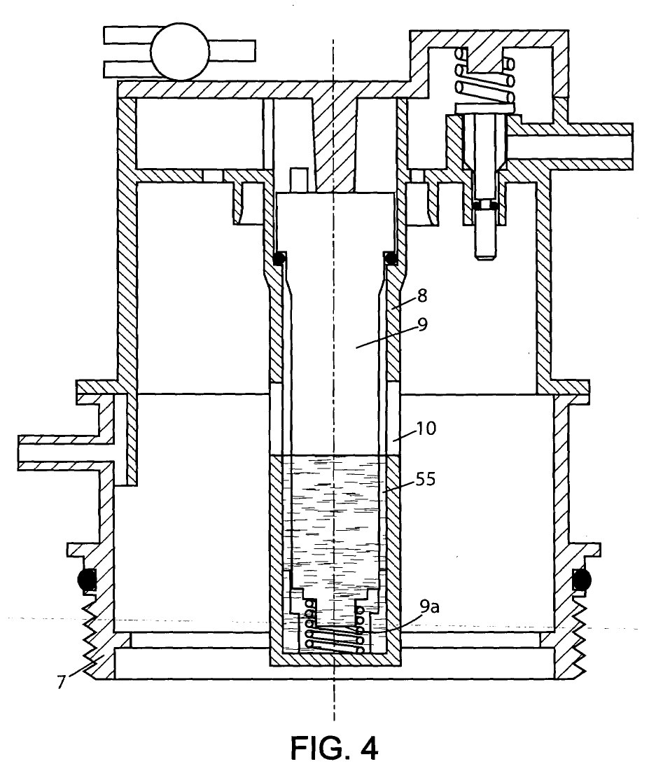

The filter unit 24 forms a one-piece structure shown more particularly in FIG. 3. The filter unit 24 essentially comprises a first filter 4, a fabric-covered tube 5, a second filter 13, a bottom end plate 18, an intermediate plate 19, and a top end plate 21. The filter 4 and the fabric-covered tube 5 are tubular, coaxial, and extend between the bottom end plate 18 and the intermediate plate 19 along a longitudinal axis 60. The second filter 13 is tubular, extending the first filter 4, with the first filter 4 and the second filter 13 sharing a common axis.

The function of the first filter 4 is to retain the largest solid particles and to cause any water contained in the diesel that penetrates into the device 50 via the inlet 1 to coalesce. The first filter 4 advantageously presents straight pleating formed by a two-layer non-woven fabric. The first layer in the diesel flow direction (outer layer) is preferably a so-called “melt-blown” layer constituted by polyester fibers. It presents pores of a size such that about 50% of the flow of diesel passing through it passes through pores of a size smaller than 11 micrometers (μm), and about 50% of the flow of diesel passing through it passes through pores of a size greater than 11 μm. The second layer (inner layer) situated downstream from the first layer in the diesel flow direction is advantageously constituted by cellulose fibers impregnated with polymerized phenolic resin. It presents pores having a size such that 50% of the flow of diesel passing through it passes through pores of a size smaller than 9 μm and about 50% of the flow of diesel passing through it passes through pores of a size greater than 9 μm. Consequently, the mean size of the pores in the first layer is about 11 μm and that of the pores in the second layer is about 9 μm. There thus exists a porosity gradient that decreases going from upstream to downstream through the filter.

The surface tension (energy) of the first and second layers of the first filter 4 advantageously lies in the range 40 mN/m to 80 mN/m, preferably in the range 40 mN/m to 72 mN/m, and ideally in the range 40 mN/m to 60 mN/m. Since the surface tension of water is 72 mN/m, the first filter 4 is consequently preferably slightly hydrophobic.

The fabric-covered tube 5 comprises a perforated plastics tube 5″ carrying a fabric 5′. The fabric 5′ is advantageously made of polyester and preferably of polyester terephthalate (PET). The fabric 5′ advantageously constitutes a square-type mesh having openings (porosity) of about 25 μm to 27 μm. The fabric 5′ is preferably treated to be hydrophobic, having surface tension lying in the range 20 mN/m to 40 mN/m, and preferably in the range 20 mN/m to 30 mN/m. It is preferably overmolded onto the tube 5″ that constitutes a support therefor.

Preferably, the second filter 13 advantageously presents straight pleating constituted by a two-layer non-woven fabric. The (outer) first layer is advantageously a so-called “melt-blown” layer constituted by polyester fibers. The (inner) second layer is disposed downstream from the first layer relative to the diesel flow direction and is advantageously constituted by cellulose fibers impregnated with a polymerized phenolic resin. The mean size of the pores of the first layer is preferably 11 μm, and that of the pores of the second layer is preferably 5 μm, so that there exists a porosity gradient that decreases going from upstream to downstream through the filter. In a variant, the second filter 13 could be constituted, for example, by a single layer comprising cellulose fibers and glass fibers.

In FIG. 1, the path for diesel through the device 50 between the inlet 1 and the outlet 16 is represented by a line referenced 29. The diesel is sucked from the fuel tank of the vehicle and enters the device 50 via the cannula 1. A vertical wall 2 integrated in the upper body 3 extends in register with the inlet 1 to form a baffle dispersing the flow of diesel that penetrates into a cavity 45 extending between the inlet 1 and the first filter 4.

The diesel that has passed radially through the first filter 4, from the periphery towards the center, penetrates into a cavity 46 extending between the first filter 4 and the fabric-covered tube 5. Since droplets are enlarged in the first filter 4, most droplets are of a size that is too big to pass through the hydrophobic fabric 5′, so that the droplets move downwards under gravity along said fabric 5′ inside the cavity 46, so as to pass through an orifice 38 formed through the bottom end plate 18 and be collected in a settling zone 51 formed in the bottom 6, as represented diagrammatically by a dashed line 43 showing the main path of water droplets in FIG. 1. In conventional manner, the water may be evacuated via a bleed orifice located in the bottom portion of the filter vessel, extending from the inside of the settling zone 51 to the outside of the filter and closed by a bleed screw, with it then being possible to bleed off water prior to changing a used filter unit 24.

The diesel that has passed through the fabric 5′ penetrates into a cavity 47 extending between the fabric-covered tube 5 and the inlet 9a of a pump module 9. The upper body 3 includes a tubular sheath 8 extending along the longitudinal axis 60 and coaxial with the first filter 4, the second filter 13, and the fabric-covered tube 5. The sheath 8 presents a bottom 8a and defines an inside space 42. It presents inlet orifices 10 remote from the bottom 8a and situated above the inlet 9a of the pump module 9.

Diesel is delivered under pressure via the outlet 9b of the pump module 9 into a cavity 48 extending between the outlet 9b of the pump module 9 and the second filter 13. Diesel then passes through the second filter 13 radially from the periphery towards the center, after which it penetrates in a cavity 49. The second filter 13 retains the major fraction of the particles still remaining in the diesel present in the cavity 48. The diesel then leaves the device 50 via the outlet 16.

The bottom end plate 18 presents radial fingers 27 coming into abutment against a shoulder 28 of the lower body 7, in order to position the filter unit 24 in the housing.

In the embodiment shown in FIG. 1, the intermediate plate 19 has a first portion 19′ and a second portion 19″ that are spaced apart from each other by ribs 34, leaving between the two portions 19′ and 19″ of the intermediate plate 19 a space 52 suitable for allowing gas to flow therethrough. Thus, the gas contained in the diesel present in the cavity 45 can be exhausted towards the outlet 16 of the device by passing through the space 52 arranged above the first filter 4 and the fabric-covered tube 5, so as to shunt the first filter 4 and the fabric 5′ on penetrating into the cavity 47, as represented by the path referenced 44 in FIG. 1. As shown in particular in FIG. 2, the portion 19′ is held by snap-fastening to the portion 19″ via an annular collar 53 engaging a rim 32, a groove 31 formed in the annular collar being calibrated to allow gas to pass therethrough while preventing a flow of liquid.

The annular plate 19, and more precisely its top portion 19′ includes a first flexible lip 20a providing sealing between the plate 19 and the sheath 8, and a second flexible lip 20b providing sealing between the intermediate plate 19 and the upper body 3. More precisely, the lip 28a provides sealing between the cavity 49 and the cavity 47 towards which it faces, while the lip 20b provides sealing between the cavity 48 and the cavity 45 towards which it faces. Consequently, it should be observed that the lips 20a and 20b are flexed (oriented) in the upstream direction of the diesel flow circuit 29.

The top end plate 12 has a main portion extending perpendicularly to the longitudinal direction 60 and including a tubular portion 30 that is diesel-proof presenting an annular bead 22 or “pipe insert” that comes into contact with a tubular portion 54 of the upper body 3. The annular plates 18, 19, and 21 extend generally perpendicularly to the longitudinal direction 60 and are secured to the first filter 4 and to the second filter 13 by adhesive-bonding, welding, a hot-melt adhesive, or the like.

A tube 23 that is perforated to allow diesel to pass through extends coaxially with the second filter 13, axially between the top end plate 21 and the intermediate plate 19, and radially between the sheath 8 and the second filter 13. The perforated tube 23 is snap-fastened at its axial ends to the top end plate 21 and the intermediate plate 19. Similarly, the perforated tube 5″ is snap-fastened at its axial end to the intermediate plate 19 and the bottom end plate 18.

As shown in FIG. 3, the filter unit 24 constitutes a one-piece assembly comprising the first filter 4, the second filter 13, the fabric-covered tube 5, the perforated tube 23, the bottom end plate 18, the intermediate plate 19, and the top end plate 21. The filter unit 24 also comprises an annular sealing gasket 17 presenting, in section, three lobes 17a, 17b, and 17c. The portion 17a is tightly engaged in an annular groove 64 in the bottom end plate 18, while the portions 17b and 17c define two curved lips spreading progressively away from each other (diverging apart) from the portion 17a so as to press against the screwed-on bottom 6 and thus provide sealing between the settling zone 51 and the cavity 45. Thus, because of the flexibility of its lips 17b and 17c, the gasket 17 serves to compensate for variations in dimensions concerning the end plate 18, the lower body 7, and the bottom 6. In a variant, the gasket 17 could have a single lip only, being replaced by an O-ring, or an annular gasket of oval section that is sufficiently tall and flexible in the longitudinal direction 60 to compensate for the above-mentioned variations in dimensions. The gasket 17 is advantageously made of rubber or of a thermoplastic elastomer material.

As shown in FIG. 4, by unscrewing the bottom 6 from the lower body 7, it is possible to withdraw the filter unit 24 from the housing in order to replace it. The water contained in the settling zone 51 is then emptied out and the diesel contained in the housing flows essentially under gravity. Nevertheless, since the inlet orifices 10 in the sheath are spaced apart from the bottom 8a of the sheath and the inlet 9a of the pump module 9, and more precisely are situated above them, the sheath 8 retains diesel below the orifices 10. Consequently, there is a volume 55 of diesel that cannot flow away under gravity, such that the inlet 9a of the pump module 9 remains immersed in diesel, thus avoiding any risk of the pump 9 no longer being primed when it is put back into operation.

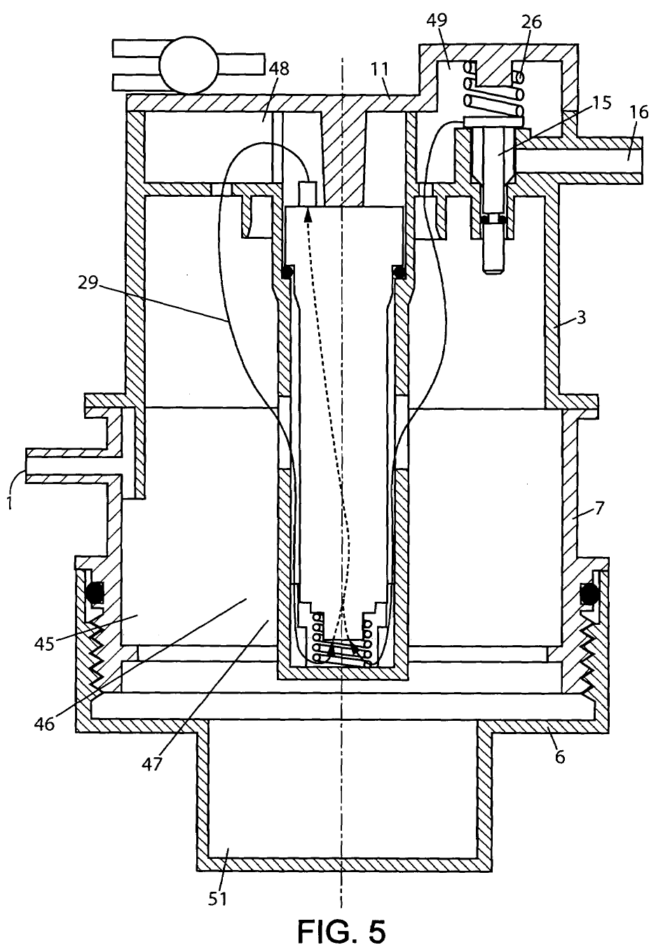

Close to the outlet 16, the device 50 further comprises a valve member 15 that is movable between an open position shown in FIG. 1 and a closed position shown in FIGS. 4 and 5 in which it bears against a valve seat 62 made in the upper body 7. The valve member 15 is urged towards its closed position by a spring 26, and it has a rod 25 against which the end plate 21 of the filter unit 24 comes to bear so as to bring the valve member 15 into the open position when the filter unit 24 is in place in the housing with the bottom 6 properly screwed onto the lower body 7. As shown in FIG. 5, when there is no filter unit in the housing, even after the bottom 6 has been screwed back onto the lower body 7, the valve member 15 prevents diesel from leaving the cavity 49 towards the outlet 16. Consequently, the engine situated downstream from the outlet 16 is not fed with diesel that has not been filtered because there is no filter unit. The absence of a filter unit 24 thus puts the cavities 45, 46, 47, 48, and 49 into communication, such that the pump module 9 sets the diesel inside the housing into circulation. The pressure inside the housing in the absence of a filter unit 24 is thus substantially equal to the head losses of the diesel flowing inside the housing without a filter unit 24, and thus remains relatively low.

The gas that escapes through the space 52 between the portion 19′ and the portion 19″ of the intermediate plate 19 avoids bubbles of gas accumulating in the top portion of the first filter 4 in the cavity 45. In the absence of high pressure imposed by the pump unit 9, the gas finds it difficult to pass through the first filter 4. The accumulation of gas inside the top portion of the cavity 45, upstream from the first filter 4, reduces the surface area of the first filter 4 that is available for filtering diesel by a corresponding amount, thereby increasing the speed with which the fuel flows through the first filter 4 and the fabric 5′, and reducing the effectiveness of filtering and of water separation performed by the first filter and the hydrophobic fabric 5′. Once the gas has reached the cavity 47 it is exhausted under pressure by the pump 9 and forced to pass through the second filter 13 so as to be exhausted outside the device 50 via the outlet 16.

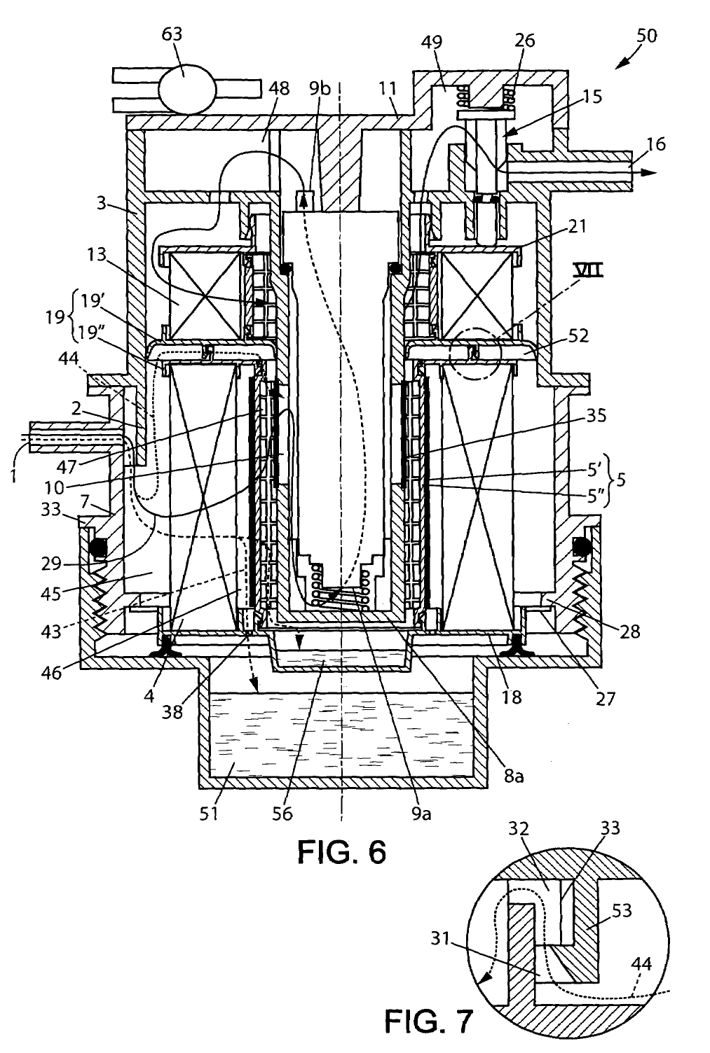

The device 50 shown in FIGS. 6 and 7 differs from that shown in FIGS. 1 to 5 in that the snap-fastener means 33, 53 between the portions 19′ and 19″ of the intermediate plate 19 are disposed axially between the first filter 4 and the second filter 13, such that the space 52 is defined by the snap-fastener means 33, 53, thus avoiding the need to provide ribs 34. The dimensioning of the grooves 31, 32 formed respectively in the snap-fastener means 53, 33 of the portion 19″ and the portion 19′ of the intermediate plate 19 is determined in such a manner as to allow only gas to pass and not any diesel.

In addition, a second fabric-covered tube 35 is placed at the inlets of the orifices 10 and a second settling zone 56 is provided in the bottom end plate 18 in order to recover droplets of water that have run down over the second fabric-covered tube 35 falling under gravity into the cavity 47. Advantageously, the fabric-covered tube 35 is constituted by a hydrophobic fabric overmolded on the plastics material of the sheath 8 and it is constituted by a hydrophobic fabric of material similar to that of the hydrophobic fabric 5′ but having pores that are smaller than those of the hydrophobic fabric 5′. The size of the pores in the hydrophobic fabric of the second fabric-covered tube 35 may lie in the range about 10 μm to about 20 μm, for example.

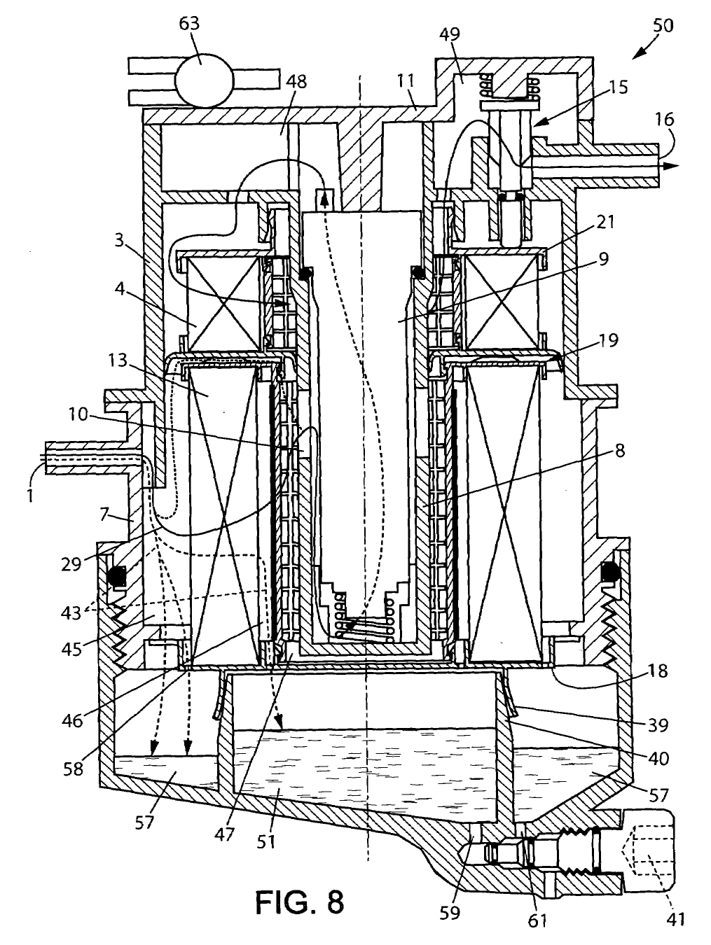

In certain applications, it is possible for the droplets of water to be larger, making it difficult for them to penetrate into the filter media of the first filter element 4, so that they accumulate upstream from the first filter element 4 inside the cavity 45. Consequently, the device 50 shown in FIG. 8 differs from the device shown in FIGS. 1 to 5 essentially in that an annular settling zone 57 is provided in the bottom 6 for collecting the droplets of water that run down under gravity upstream from the first filter 4 into the cavity 45. An orifice 58 is made in the bottom end plate 18 so as to allow said droplets to pass through. Two bleed channels 59, 61 enable the settling zones 56, 57 to be emptied by removing a bleed screw 41. So long as the bleed screw 41 is in place, not only does it close the bleed orifices 59, 61, but it also isolates them from each other, and consequently isolates the settling zones 56 and 57 from each other. In addition, sealing between the settling zones 51 and 57 is achieved by means of a tubular sealing lip 39 projecting axially from the bottom end plate 18. The tubular sealing lip 39 co-operates with a frustoconical surface formed at the end of a tubular portion 40 of the bottom 6.

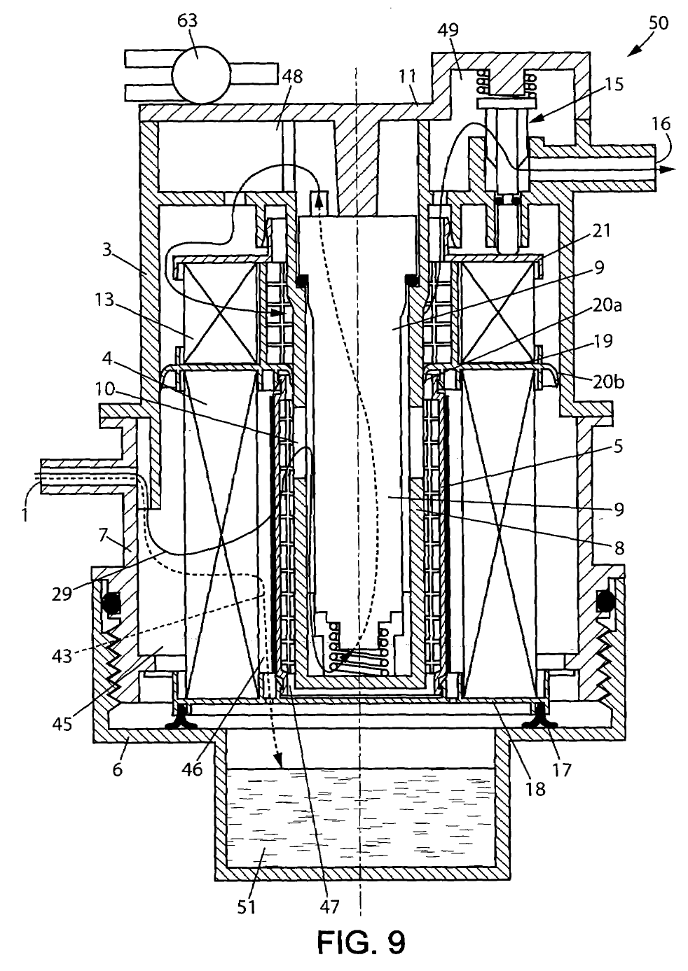

The device 50 shown in FIG. 9 differs from the device shown in FIGS. 1 to 5 in that the portions 19′ and 19″ of the intermediate plate 19 are combined to form a single piece.

In very cold weather, particles of paraffins (long molecular chains) form in the fuel and can temporarily clog the filter elements. Consequently, the filter of the invention may also be provided with means for heating the fuel upstream from the first filter element 4. By way of example, the heater means may be of the type comprising:
a recirculation valve used in very cold weather to redirect excess fuel coming from the high pressure pump and/or form the common fuel-feed rail and the injectors into the upstream zone of the first filter element so as to heat the fuel in this zone, thus avoiding the formation of particles of paraffins. Recirculation devices make use of a capsule of wax that is sensitive to the temperature of the fuel and that moves a recirculation valve are themselves known, and one such valve is shown diagrammatically in FIGS. 1 to 9 under reference 63; or
an electrical heater of the resistant element type, a resistance with a positive temperature coefficient (PTC), or a resistive track silk-screened on an electronic card could also be used for heating diesel upstream from the device 50.

It should be observed that the valve 15 could optionally be mounted on a filter device other than a filter device of the invention, insofar as the filter device need merely be such that in the absence of the filter module 24, said valve is in the closed position, and when the filter module 24 is placed inside the filter device, the valve is opened.

We claim:

1. A device for filtering fuel, in particular diesel, the device comprising a housing containing:
a fuel flow circuit extending between an inlet and an outlet;
a first particle filter element adapted to cause the water contained in the fuel to coalesce in the form of droplets;
a second particle filter element disposed downstream from the first filter element in the fuel flow circuit; and
a water separation fabric interposed between the first filter element and the second filter element in the fuel flow circuit and adapted to form a barrier against droplets of water.

2. A device according to claim 1, wherein the first filter element and the second filter element are tubular, share a common axis, and are disposed one extending the other.

3. A device according to claim 2, wherein the first filter element and the second filter element define internally an inside space in which a pump is disposed.

4. A device according to claim 3, wherein the pump is disposed downstream from the separation fabric in the fuel flow circuit.

5. A device according to claim 3, wherein the pump is disposed in a fuel-tight tubular sheath presenting a bottom, said sheath defining a container fed upstream from the pump in the fuel flow circuit by at least one feed orifice remote from the bottom, and the pump presenting an inlet and an outlet, said inlet being disposed between the feed orifice and the bottom of the sheath.

6. A device according to claim 5, wherein:
the sheath is tubular and extends in the inside space; and
the housing comprises a body in which the sheath is integrated, and said feed orifice is pierced radially through the sheath.

7. A device according to claim 5, wherein a secondary water separation fabric is disposed in said at least one feed orifice, and a bottom end plate secured to the bottom end of the first filter element includes a settling zone for collecting the water separated by the second fabric, and which is disposed between the first element and the secondary fabric in the fuel flow circuit.

8. A device according to claim 7, wherein the sheath is overmolded on the secondary water separation fabric.

9. A device according to claim 3, wherein the filter assembly includes means for isolating the downstream end of the pump from the upstream end of the pump such that in the absence of the filter assembly the downstream end of the pump and the upstream end of the pump communicate with each other than through the pump.

10. A device according to claim 2, wherein the first filter element, the second filter element, and the separation fabric define a removable one-piece filter unit.

11. A device according to claim 3, wherein the first filter element, the second filter element, and the separation fabric define a removable one-piece filter unit, the filter unit having a plate separating the first filter element and the second filter element, said plate being provided with at least one lip facing towards the first filter element, and the pump is disposed between the first filter element and the second filter element in the fuel flow circuit.

12. A device according to claim 1, further comprising a passage for passing the gas contained in the fuel from upstream to downstream relative to the first filter element in the fuel flow circuit.

13. A device according to claim 1, wherein the first filter presents surface energy lying in the range 40 mN/m to 60 mN/m, and the hydrophobic fabric presents surface energy lying in the range 20 mN/m to 30 mN/m.

14. A device according to claim 1, further including a valve having a closed position in which it prevents fuel from flowing through the outlet of the device, and an open position in which it allows fuel to flow through the outlet of the device, said valve being urged towards its closed position by pressure means and presenting a rod coming to bear against the filter assembly comprising the first filter element, the second filter element, and the separation fabric and serving to push the valve towards its open position.

15. A device according to claim 1, wherein the device further comprises a settling zone upstream from the first filter element in the fuel flow circuit for collecting the water separated from the fuel by the first filter element.

16. A one-piece filter unit for filtering diesel in particular, the unit comprising:
a first tubular element for filtering particles and adapted to cause the water contained in the fuel to coalesce in the form of droplets;
a tubular water separation fabric disposed coaxially with the first filter element and in register therewith, said water separation fabric being adapted to form a barrier against droplets of water; and
a second tubular element for filtering particles, disposed on the same axis as the first filter element, and in line therewith.
